(19) United States
(12) Patent Application Publication
(10) Pub. No.: US 2024/0202458 A1
(43) Pub. Date: Jun. 20, 2024

(54) GENERATING PROMPT RECOMMENDATIONS FOR NATURAL LANGUAGE PROCESSING TASKS

(71) Applicant: Amazon Technologies, Inc., Seattle, WA (US)

(72) Inventors: Sheng Zha, New York, NY (US); Miguel Ballesteros Martinez, New York, NY (US); Yassine Benajiba, Briarcliff Manor, NY (US); Cole Hawkins, New York, NY (US); Aditya Rawal, Mountain View, CA (US); Dhananjay Ram, Kirkland, WA (US); Min Rong Samson Tan, Mountain View, CA (US); Abhinav Goyal, Snohomish, WA (US); Brant Swidler, Kauneonga Lake, NY (US)

(73) Assignee: Amazon Technologies, Inc., Seattle, WA (US)

(21) Appl. No.: 18/067,680

(22) Filed: Dec. 16, 2022

(51) Int. Cl. G06F 40/40; G06F 40/279

(52) U.S. Cl. CPC G06F 40/40; G06F 40/279; G06F 40/205

(57) ABSTRACT

Prompt discovery is performed for identifying prompts to natural language processing machine learning models. A request to determine a prompt for a natural language processing task performed by a pre-trained natural language processing machine learning model may be received. A task classification for the natural language processing task may be determined and candidate prompts for the natural language processing prompt task collection selected. Respective prompt results for the candidate prompts are evaluated to generate a prompt recommendation for the natural language processing task.

### BACKGROUND

Machine-learned models and data-driven systems have been increasingly used to help make decisions in application domains such as financial services, healthcare, education, and human resources. These applications have provided benefits such as improved accuracy, increased productivity, and cost savings. This trend is the result of a confluence of factors, such as ubiquitous connectivity, the ability to collect, aggregate, and process large amounts of fine-grained data using cloud computing, and improved access to increasingly sophisticated machine learning models that can analyze this data.

### BRIEF DESCRIPTION OF THE DRAWINGS

FIG. 1 illustrates a logical block diagram of a prompt development system for natural language processing machine learning models that generates prompt recommendations and prompt development, according to some embodiments.

FIG. 2 illustrates an example provider network that may implement a machine learning service that implements prompt discovery and development for natural language processing tasks, according to some embodiments.

FIG. 3 illustrates a logical block diagram of interactions to submit prompts for discovery, selection, and development through a machine learning service, according to some embodiments.

FIG. 4 illustrates a logical block diagram illustrating prompt discovery, according to some embodiments.

FIG. 5A illustrates an example prompt discovery interface for submitting a discovery request, according to some embodiments.

FIG. 5B illustrates an example prompt discovery interface providing a prompt recommendation, according to some embodiments.

FIG. 6 is a logical block diagram illustrating prompt development for NLP

tasks, according to some embodiments.

FIG. 7A is an example prompt development interface for performing prompt and NLP ML model tuning, according to some embodiments.

FIG. 7B is an example prompt development interface for an adaption job result, according to some embodiments.

FIG. 8 is a logical block diagram illustrating model deployment for tune NLP ML models, according to some embodiments.

FIG. 9 is a high-level flowchart illustrating various methods and techniques for generating prompt recommendations for NLP processing tasks, according to some embodiments.

FIG. 10 is a high-level flowchart illustrating various methods and techniques for performing prompt development and tuning using a selected prompt from a task collection, according to some embodiments.

FIG. 11 illustrates an example system to implement the various methods, techniques, and systems described herein, according to some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as described by the appended claims. The headings used herein are for organizational purposes only and are not meant to be used to limit the scope of the description or the claims. As used throughout this application, the word “may” is used in a permissive sense (e.g., meaning having the potential to), rather than the mandatory sense (e.g., meaning must). Similarly, the words “include,” “including,” and “includes” mean including, but not limited to.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

### DETAILED DESCRIPTION OF EMBODIMENTS

Various techniques of generating prompt recommendations and performing prompt development for natural language processing (NLP) machine learning (ML) models are described herein. Machine learning models can be shaped by many different factors when used in different application. In various scenarios, understanding why a machine learning model made a decision (e.g,. a prediction or other inference) and what impacted that prediction may be important to determine whether a model is performing tasks correctly in applications that use the machine learning model. For example, NLP may use ML models to extract insights about the content of documents. Such NLP models develop insights by recognizing the entities, key phrases, language, sentiments, events, and other common elements in a document. Both pre-trained NLP ML models and custom NLP ML models may be used for entity recognition, classification, or various other natural language processing tasks.

Machine learning refers to a discipline by which computer systems can be trained to recognize patterns through repeated exposure to training data. In unsupervised learning, a self-organizing algorithm learns previously unknown patterns in a data set without any provided labels. In supervised learning, this training data includes an input that is labeled (either automatically, or by a human annotator) with a “ground truth” of the output that corresponds to the input. A portion of the training data set is typically held out of the training process for purposes of evaluating/validating performance of the trained model. The use of a trained model in production is often referred to as “inference,” or a “prediction” during which the model receives new data that was not in its training data set and provides an output based on its learned parameters. The training and validation process may be repeated periodically or intermittently, by using new training data to refine previously learned parameters of a production model and deploy a new production model for inference, in order to mitigate degradation of model accuracy over time. NLP ML models, for example, may be trained using training data sets of documents or other sets of natural language (e.g., human language) to perform various natural language processing tasks, including, but not limited to information extraction (e.g., named entity recognition, relation extraction, coreference resolution, events extraction and joint entity relation extraction), text classification (e.g., classification, sentiment, relation classification, topic classification, paraphrase identification, word sense disambiguation, and natural language inference), question answering (e.g., extractive QA and close-book QA), summarization (e.g., extractive summarization and abstractive summarization), generation (e.g., sentence completion and structure to text), among others.

In various embodiments, NLP ML models may use as an input to produce an inference a prompt. A prompt may be sentence(s), phrase(s), or other series of words, symbols or other portions text of natural language. For example, an NLP ML model may be trained to answer questions about an input text. The prompt to produce an inference about the input text may be “The names mentioned in this text are”. Based on the prompt and the input text, the NLP ML model may generate an inference of the names of the input text, “John, Jane, Bill, Bob, and Alice”. The use of NLP ML models that perform tasks, like the question answering task above, may be integrated into various systems, services, or applications in order to enhance the capabilities that such systems, services, or applications to better interact with human users. Therefore, techniques that can produce better NLP ML models for integration with these systems, services, or applications are highly desirable.

Different NLP ML models may achieve different results for NLP tasks. For example, some NLP ML models may produce better results for text summarization, as they may have been trained or developed specifically for that task. Other NLP ML models may generalized for performing multiple NLP tasks. In addition to the training data and design of NLP ML models, the influence of a prompt on NLP ML model performance may vary, with variance of prompt performance used for a specific NLP task as well as variance of prompt performance across different NLP ML models.

Some prompts may, for example, provide a better (e.g., more accurate) inference than others with regard to a particular NLP task and/or NLP ML model. In some scenarios, a developer may not have been involved with the initial training or design of an NLP ML model and thus may not have insight into the performance of particular prompts for the NLP ML model. For instance, in the example above, the prompt “What are the names in the text?” or “List the names in the text” may provide a better inference given the same input text. Discovering which prompt is optimal for the developer's use may be difficult given the large number of possible variations for an NLP task prompt. Therefore, in various embodiments, various techniques for discovering prompts for an NLP task may be implemented which may account for a particular application's use of the NLP ML model and prompt.

Additionally, even if an optimal prompt can be identified (or may be known or otherwise recommended, such as by an NLP ML model designer), other aspects of NLP ML model task performance may affect how the prompt and NLP ML model performs for a particular application. Various techniques for adapting both the prompt and NLP ML model may be implemented, as well as various other features for controlling the performance of the prompt and NLP ML model. Thus, there can be various possible ways to develop the NLP ML model and prompt for a particular application. In various embodiments, various techniques for prompt-based development of NLP ML models may be implemented to allow for full suite of development tools that consider both an NLP ML model and a prompt as input to the NP ML model.

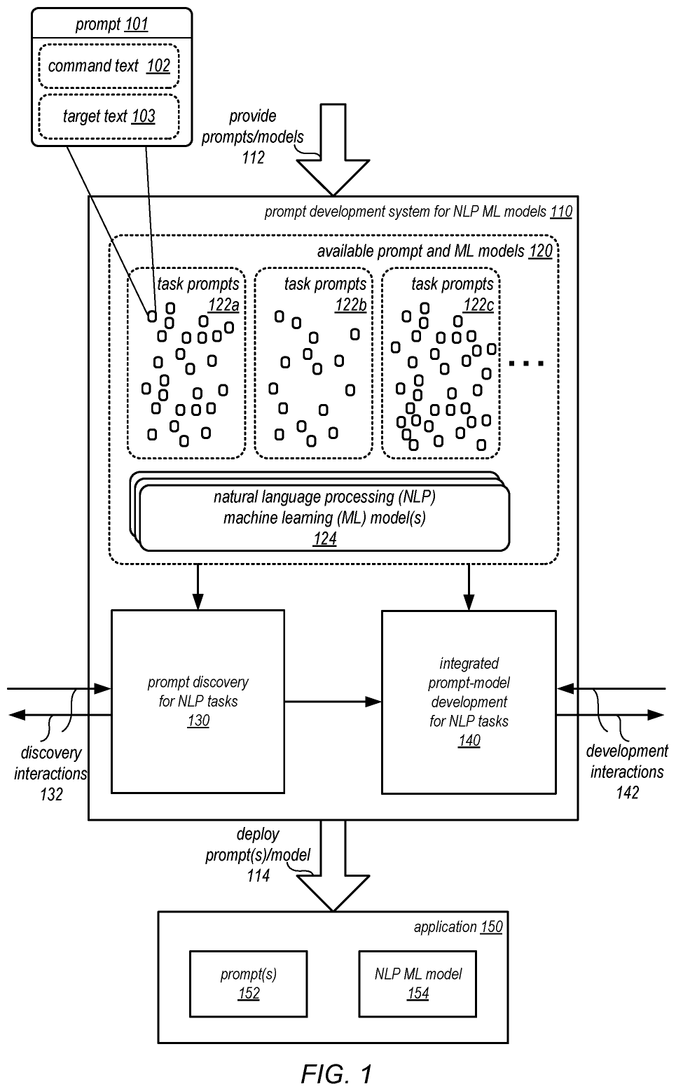

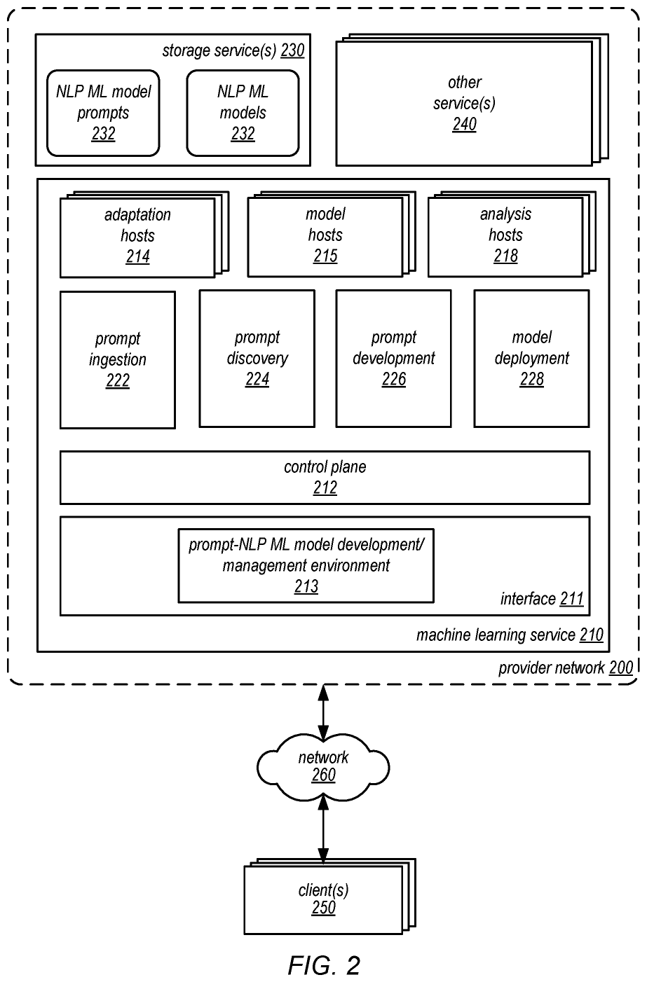

FIG. 1 illustrates a logical block diagram of a prompt development system for natural language processing machine learning models that generates prompt recommendations and prompt development, according to some embodiments. Prompt development system for NLP ML models 110 may be a stand-alone system, application, or service, or may be implemented as part of a machine learning service of a provider network (e.g., machine learning service 210 discussed below with regard to FIGS. 2-8). In various embodiments, prompt development system for NLP ML models 110 may host, support, and collect NLP ML models, such as NLP ML model(s) 124 and task prompts, such as prompt 101, which may be grouped into collections, such as task prompt collections 122a, 122b, and 122c, for particular NLP ML model(s) 124 and/or particular NLP tasks (e.g., name recognition, place recognition, summary, etc.). Prompts may, in various embodiments, include input for performing an NLP task. As illustrated in FIG. 1. a prompt 101 may include a command text 102 (e.g., a question or instruction) and a target text 103 (e.g., an input document, paragraph, phrase, collection of documents, etc.). In some embodiments, a prompt 101 may only include the command text 102. In some embodiments, the prompt 101 may only include the target text 103 (e.g., the document or a sentence to complete). In some embodiments, there may be multiple features or components of prompts. For example, a command text 102 may have an instruction feature (e.g., summarize) and a style feature (e.g., in the style of Shakespeare).

NLP ML model(s) 124 may be pre-trained or custom NLP ML models and may be based on various different ML model architectures (e.g., Generative Pre-trained Transformer (GPT)-based ML models), and frameworks (e.g., PyTorch, TensorFlow, etc.). These NLP Models may be trained to perform various NLP processing tasks, such as document or dialogue summarization, paraphrasing, structure to text, relation extraction and/or coreference resolution, among others.

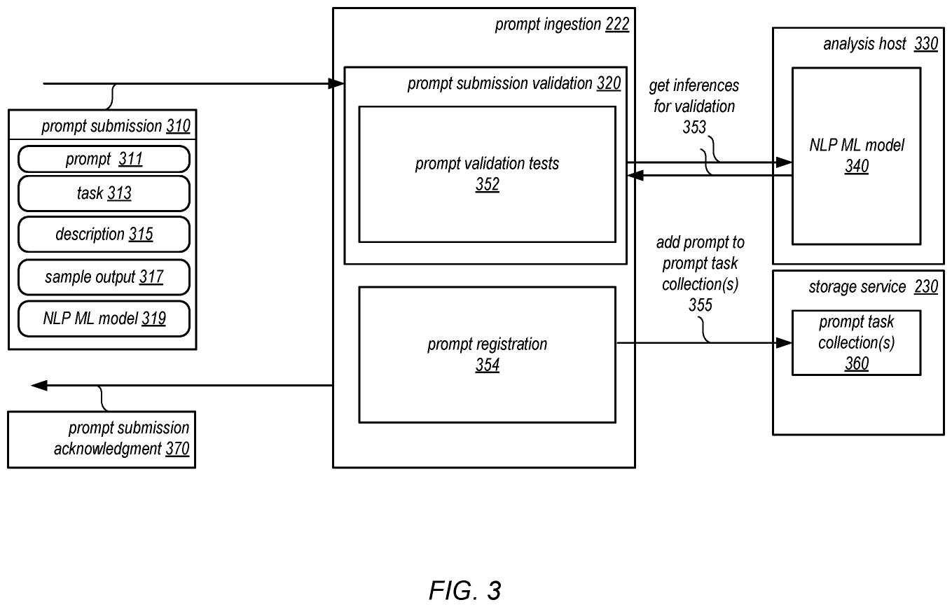

In some embodiments, prompt development system for NLP ML models 110 may provide an interface (e.g., as discussed below with regard to FIG. 3) for submitting or uploading prompts and NLP models, as indicated at 110. For example, NLP ML model developers can upload various versions of NLP ML models 124 for selection and development. Similarly, various task prompts can be provided and associated with task collection for an NLP ML model and/or NLP task. In this way, prompt development system for NLP ML models 110 can act as a development repository that makes different models and prompts available for analysis, optimization, or other development uses from model producers and prompt producers for use by NLP ML model developers that are integrating NLP ML models and prompts into an application.

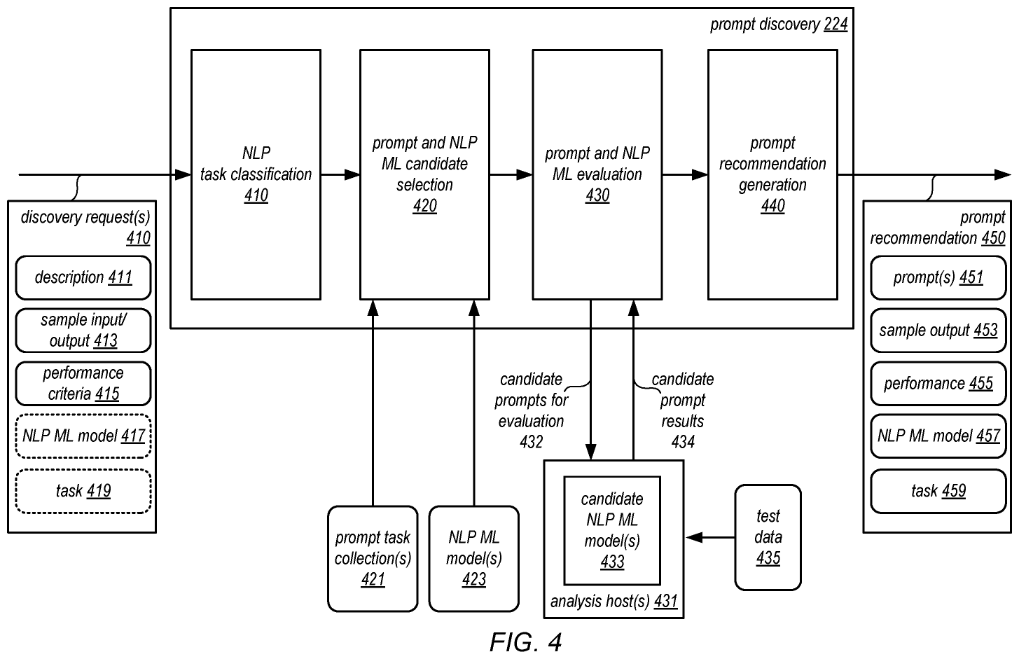

As discussed above, techniques for discovering prompts for different NLP tasks can help to optimize the performance of an NLP task for integration with a particular application. Prompt discovery for NLP tasks 130 may be implemented as part of prompt development system for NLP ML models 110 to provide various search and recommendations for prompts according to various analysis and search techniques, as discussed in detail below with regard to FIGS. 4-5B and 9. For example, various discovery interactions 132 including guided, interactive, or other types of requests through various types of interfaces may allow for the submission of information to discover a prompt for an NLP task as well as refine, evaluate, and select from the many available task prompts 122.

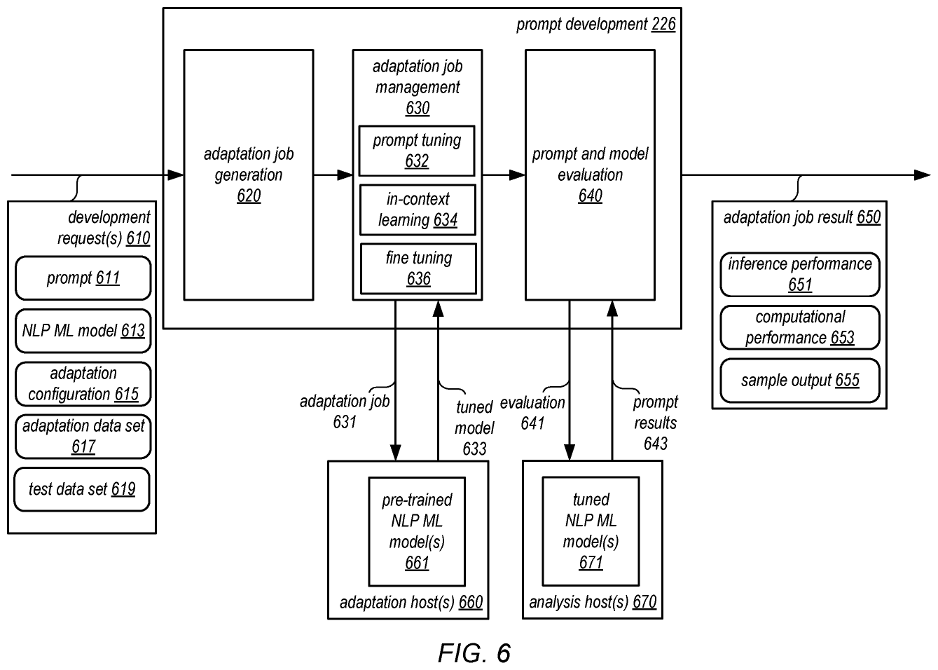

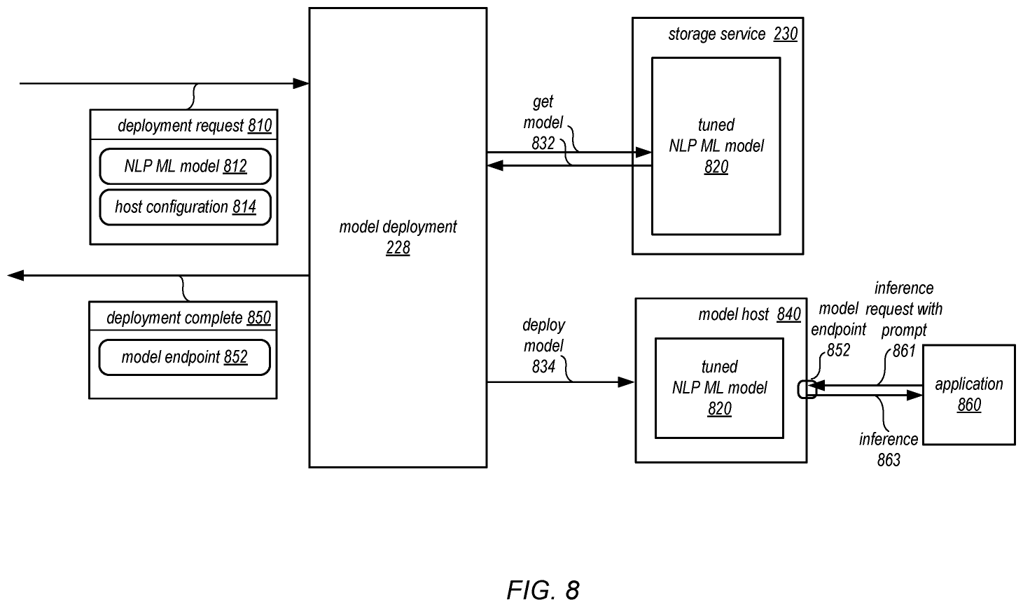

For prompt-based NLP ML model development, integrated prompt-model development for NLP tasks 140 may be implanted as part of prompt development system for NLP ML models 110 to provide development tools for optimizing or otherwise developing both a task prompt and NLP ML model. Task prompts may be selected through prompt discovery 130 or may be directly selected from available tasks prompts and models 120. Development interactions 142, as discussed in detail below with regard to FIGS. 6-7B and 10, may allow for different configurations, parameters, or other features of both a prompt and an NLP ML model to be implemented and evaluated. In this way, optimal prompt-NLP ML model combinations can be developed and deployed, as indicated at 114 in various applications 150, which may invoke prompt(s) 152 as part of performing an application operation using NLP ML model 154, as discussed in detail below with regard to FIG. 8.

Please note that the previous description of is a logical illustration of NLP ML models, task prompts, discovery interactions, and development interactions and thus is not to be construed as limiting as to the machine learning system.

This specification continues with a general description of a provider network that implements multiple different services, including a machine learning service, which may implement prompt discovery and development for natural language processing tasks. Then various examples of, including different components, or arrangements of components that may implement these are discussed. A number of different methods and techniques to implement prompt discovery and development for natural language processing tasks are then discussed, some of which are illustrated in accompanying flowcharts. Finally, a description of an example computing system upon which the various components, systems, devices, and/or nodes may be implemented is provided. Various examples are provided throughout the specification.

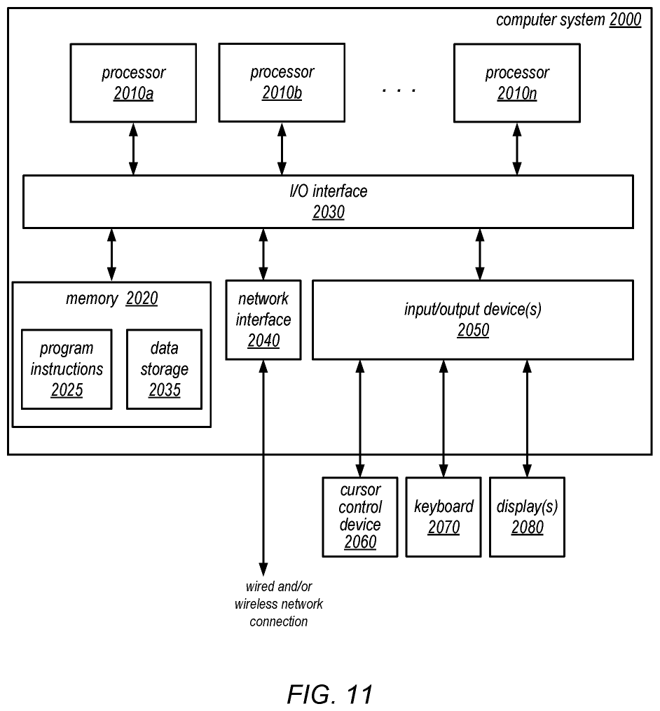

FIG. 2 illustrates an example provider network that may implement a machine learning service that implements prompt discovery and development for natural language processing tasks, according to some embodiments. Provider network 200 may be a private or closed system or may be set up by an entity such as a company or a public sector organization to provide one or more services (such as various types of cloud-based storage) accessible via the Internet and/or other networks to clients 250, in one embodiment. Provider network 200 may be implemented in a single location or may include numerous data centers hosting various resource pools, such as collections of physical and/or virtualized computer servers, storage devices, networking equipment and the like (e.g., computing system 2000 described below with regard to FIG. 11), needed to implement and distribute the infrastructure and services offered by the provider network 200, in one embodiment. In some embodiments, provider network 200 may implement various computing resources or services, such as machine learning service 210, storage service(s) 230, and/or any other type of network-based services 240 (which may include a virtual compute service and various other types of storage, database or data processing, analysis, communication, event handling, visualization, data cataloging, data ingestion (e.g., ETL), and security services), in some embodiments.

In various embodiments, the components illustrated in FIG. 2 may be implemented directly within computer hardware, as instructions directly or indirectly executable by computer hardware (e.g., a microprocessor or computer system), or using a combination of these techniques. For example, the components of FIG. 2 may be implemented by a system that includes a number of computing nodes (or simply, nodes), each of which may be similar to the computer system embodiment illustrated in FIG. 11 and described below, in one embodiment. In various embodiments, the functionality of a given system or service component (e.g., a component of machine learning service 210 may be implemented by a particular node or may be distributed across several nodes. In some embodiments, a given node may implement the functionality of more than one service system component (e.g., more than one data store component).

Machine learning 210 may implement interface 211 to allow clients (e.g., client(s) 250 or clients implemented internally within provider network 200, such as a client application hosted on another provider network service like an event driven code execution service or virtual compute service) to adapt and deploy machine learning models (e.g., NLP ML models). For example, machine learning service 210 may implement interface 211 (e.g., a graphical user interface, programmatic interface that implements Application Program Interfaces (APIs) and/or a command line interface) may be implemented so that a client can submit, edit, or otherwise provide an adaption job for a machine learning model stored in storage service(s). For example, interface 211 may include prompt-NLP ML model development and management environment 213, which may provide a visual editor, adaptation script or other code editor with various development tools to create, submit, and/or otherwise interact with prompt discovery 224, prompt development 226, and model deployment 228, as discussed below. Development and management environment 213 may be a graphical interface, in some embodiments, and may provide an interface to past results generated for other models, in some embodiments. Interface 211 may allow a client to request the performance of adaptation, deployment, or other machine learning service features, in various embodiments. Although not illustrated interface 211 may include interface for other machine learning service 210 features not illustrated, such as the adaptation, deployment, or use of non-NLP ML models.

Machine learning service 210 may implement a control plane 212 to perform various control operations to implement the features of machine learning service 210. For example, control plane may monitor the health and performance of requests at different components (e.g., which may be managed by prompt ingestion 222, prompt discovery 224, prompt development 225, and model deployment 228), such as model adaptation on adaptation hosts 214, model deployment on model hosts 215, and model analysis on analysis hosts 218. These hosts 214, 215, and 218 may implement various machine learning frameworks (e.g., Tensorflow, Pytorch, MxNet, etc.) and may utilize general processing (e.g., CPUs) and/or machine learning-specialized hardware (e.g., GPUs or Tensor Processing Units (TPUs)) in order to execute tasks. If a host fails, a request fails, or other interruption occurs, control plane 212 may be able to restart a job or other process to complete a request (e.g., instead of sending a failure response to the client). Control plane 212 may, in some embodiments, may arbitrate, balance, select, or dispatch requests to different host(s), in various embodiments. For example, control plane 212 may receive requests interface 211 which may be a programmatic interface, and identify an available host to begin work on the request.

Data storage service(s) 230 may implement different types of data stores for storing, accessing, and managing data on behalf of clients 250 as a network-based service that enables clients 250 to operate a data storage system in a cloud or network computing environment. Data storage service(s) 230 may also include various kinds relational or non-relational databases, in some embodiments, Data storage service(s) 230 may include object or file data stores for putting, updating, and getting data objects or files, in some embodiments. For example, one data storage service 230 may be an object-based data store that allows for different data objects of different formats or types of data, such as structured data (e.g., database data stored in different database schemas), unstructured data (e.g., different types of documents or media content), or semi-structured data (e.g., different log files, human-readable data in different formats like JavaScript Object Notation (JSON) or Extensible Markup Language (XML)) to be stored and managed according to a key value or other unique identifier that identifies the object. In at least some embodiments, data storage service(s) 230 may be treated as a data lake. For example, an organization may generate many different kinds of data, stored in one or multiple collections of data objects in a data storage service 230. The data objects in the collection may include related or homogenous data objects, such as database partitions of sales data, as well as unrelated or heterogeneous data objects, such as image data files (e.g., digital photos or video files) audio files and web site log files. Data storage service(s) 230 may be accessed via programmatic interfaces (e.g., APIs) or graphical user interfaces.

Generally speaking, clients 250 may encompass any type of client that can submit network-based requests to provider network 200 via network 260, including requests for machine learning service 210 (e.g., a request to interact with development and management environment 213, etc.). For example, a given client 250 may include a suitable version of a web browser, or may include a plug-in module or other type of code module that can execute as an extension to or within an execution environment provided by a web browser. In some embodiments, such an application may include sufficient protocol support (e.g., for a suitable version of Hypertext Transfer Protocol (HTTP)) for generating and processing network-based services requests without necessarily implementing full browser support for all types of network-based data. That is, client 250 may be an application that can interact directly with provider network 200. In some embodiments, client 250 may generate network-based services requests according to a Representational State Transfer (REST)-style network-based services architecture, a document- or message-based network-based services architecture, or another suitable network-based services architecture.

In some embodiments, a client 250 may provide access to provider network 200 to other applications in a manner that is transparent to those applications. Clients 250 may convey network-based services requests (e.g., access requests to configure or perform explanation jobs) via network 260, in one embodiment. In various embodiments, network 260 may encompass any suitable combination of networking hardware and protocols necessary to establish network-based-based communications between clients 250 and provider network 200. For example, network 260 may generally encompass the various telecommunications networks and service providers that collectively implement the Internet. Network 260 may also include private networks such as local area networks (LANs) or wide area networks (WANs) as well as public or private wireless networks, in one embodiment. For example, both a given client 250 and provider network 200 may be respectively provisioned within enterprises having their own internal networks. In such an embodiment, network 260 may include the hardware (e.g., modems, routers, switches, load balancers, proxy servers, etc.) and software (e.g., protocol stacks, accounting software, firewall/security software, etc.) necessary to establish a networking link between given client 250 and the Internet as well as between the Internet and provider network 200. It is noted that in some embodiments, clients 250 may communicate with provider network 200 using a private network rather than the public Internet.

FIG. 3 illustrates a logical block diagram of interactions to submit prompts for discovery, selection, and development through a machine learning service, according to some embodiments. Prompt ingestion 222 may support various features to allow NLP ML model and/or prompt developers, including prompt developers that develop using pre-trained NLP ML models developed by others, to submit prompts for inclusion in a task collection. Prompt submission 310 may include the prompt 311 as a text string. Prompt submission 310 may also include various other information for the prompt 311, such as the NLP processing task 313 (e.g., as indicated by a code, label, category, or natural language description of the NLP task). In some embodiments, the NLP processing task 313 may be one of a set of task categories provided by machine learning service 210. Description 315 may be included in prompt submission 310, which may include various other information about the prompt, such as information that can be included in an entry for the prompt 311 when displayed or provided as part of prompt discovery and selection, in some embodiments. In some embodiments, submission 310 may include sample output 317. For instance, if the prompt is “What is the name of the spokesperson?”, the sample output 317 may be “The name of the spokesperson is [First name] [Last name]”. In some embodiments, prompt submission 310 may include an identifier of the NLP ML model 319 that the prompt 311 is for.

In at least some embodiments, prompt ingestion 222 may implement prompt submission validation 320. Prompt submission validation 320 may implement one or more prompt validation tests 320. Some validation tests 320 may check for valid format (e.g., valid characters, syntax, etc.), for duplicates (e.g., has this prompt already been submitted), and for improper content (e.g., offensive content, content that violates terms of service, etc.). In some embodiments, prompt validation tests 352 may include performance evaluations. For example, one (or more) analysis hosts 330 may be used to host an NLP ML model 340 (e.g., the one identified 319 or one that is identified by machine learning service 210). Using test data for an NLP processing task, like task 313, inferences may be made using the prompt 311 and obtain for validation, as indicated at 353. These inferences may then be compared with the sample output 317 and ground truth labels for the test data to determine whether the prompt's claimed sample output 317 is achieved. Such tests may be performed over an entire test set and threshold metric (e.g., accuracy) may be applied to accept or reject prompt submission 310. Prompt submission acknowledgment 370 may indicate whether prompt 311 has been accepted or rejected. If rejected, prompt submission 370 may identify the validation test that prompt 311 failed to satisfy.

Prompts may be stored or associated with prompt task collections 360 in storage service 230. Prompt registration 354 may be implemented as part of prompt ingestion 222 to maintain and update prompt task collections 360 for accept prompt submissions. For example, prompt registration 354 may update the various data structures or systems that access prompt task collections 360. In one such example, search indexes for a prompt task collection may be updated to identify prompt 311. A search index could be, for instance, an inverted index which lists unique words that appear in the collection. Various other search indexes or other data structures may be implemented in other embodiments to make the prompt available. In some embodiments, an entry for the prompt that provides information included in the submission, such as description 315, task 313, sample output 317, and NLP ML model 319 may be created, which can then be displayed or otherwise provided via interface 211 (e.g., as part of discovery or development interactions via interface 213). As indicated at 355, prompt ingestion may add the prompt to one or more task collections 360 (e.g., to a task collection for an NLP task and to a task collection for a specific NLP ML model).

FIG. 4 illustrates a logical block diagram illustrating prompt discovery, according to some embodiments. Prompt discovery 224 may provide an interactive prompt interface for handling discovery requests, such as discovery request(s) 400. Discovery request(s) 400 may be received via graphical interface (e.g., a web console or other user interface implemented as part of prompt-NLP ML model development and management 213. In some embodiments, a command line or programmatic interface may also be supported for discovery requests. Discovery request(s) 400 may include various features, such as description 411. Description 411 may be key words, terms, or other search criteria that can be used to discover prompts. In some embodiments, discovery request(s) 400 may include a sample input/output 412. For instance, sample input may be sample document, file, or other text that may be analyzed using the NLP ML model, and the sample output may an example of expected results (e.g., The most frequent sentiment of commenters on the post is [sentiment]”). In some embodiments, discovery request(s) may include performance criteria 415. Performance criteria 415 may include information such as a range or limit on time for returning a response with an inference, a range (or limit) on resources used to host an NLP ML model to generate inferences, expected size of input, among others. While in some embodiments, discovery request(s) 400 may not be NLP ML model specific, in other embodiments, an NLP ML model 417 may be specified (e.g., by name or identifier). Similarly, while in some embodiments, discovery request(s) 400 may not include an NLP task, in other embodiments, an NLP task may be 417 may be explicitly specified (e.g., by name or selection of supported/available tasks).

Prompt discovery 224 may implement NLP task classification, in some embodiments. Prompt task classification 410 may implement rules-based (e.g., using heuristics, rule sets, decision trees, etc.) task classification or other techniques, such as ML task classification models, to determine an NLP task for a discovery request 400. For example, for a rules-based task classification, NLP task classification may parse description 411, sample input/output 413, performance criteria 415 (and/or other features of discovery request(s) 400) to determine one (or more) applicable classification rules to apply. For instance, key word searches or comparisons on description 411 or sample output 413 may be used to identify a task classification rule set (e.g., action words “list” “summarize” “explain” “identify” etc., entity words, such as “person” “company” “country” “organization”). In some embodiments, an ML model may be trained to generate an encoding of a sample output 412 and return an inference that identifies an NLP task classification. In some embodiments, NLP task classification 410 may recognize explicitly specified tasks 419.

In various embodiments, prompt discovery 224 may implement prompt and NLP ML candidate selection 420. Prompt and NLP ML candidate selection 420 may utilize an NLP task classification, as well as other information from discovery request(s) 400 to select candidate prompts and (if not specifically requests) candidate NLP models for consideration. For example, prompts may be organized or identified with different prompt task collections 421. Each prompt task collection 421 may correspond to a task classification. In some embodiments, each prompt task collection 421 may also correspond to one (or more) NLP ML model(s). For instance, a text summarization task prompt collection may correspond to a text summarization NLP task. Some of the prompts in the text summarization task may correspond to NLP ML model A and other prompts in the same task collection may correspond to NLP ML model B. In some embodiments, access controls may be implemented for portions of prompts (or for entire task collections). For example, account or organization access restrictions to a prompt collection may be implemented to restrict access to developers associated with the account or organization, in some embodiments.

Candidate prompt selection may be implemented in various ways. For example, a text search based on key words identified in the description 411 or sample output 413 may be used to search an index of prompts in task collection. In some embodiments, prompts in task collections may have sample output. A comparison of sample output 413 with sample outputs of items in the prompts may be used. A similar technique could be performed using sample input (e.g., comparing sample input text with sample input text for prompts). In some embodiments, a combination of various of the comparisons discussed above (or other analyses) may be used. In some embodiments, similarity scores may be generated for prompts in a prompt task collection 421 and used to determine which (if any) prompt candidates to select. For example, if 15 prompts are scored, a ranking of the prompts by score can be used to select the top 3 prompts as candidate prompts. In some embodiments, scores may be compared with a minimum score threshold (e.g., a candidate must have a similarity score greater than 0.7 (out of a range of 0 to 1)). In some embodiments, candidate prompts may be selected and then filtered again by other considerations, such as candidate NLP ML model(s) (or a specified one) or performance criteria (e.g., a prompt with slow performance may be discarded if fast prompt performance is desired). In some embodiments, a ML model that generates similarity scores may be used to make comparisons based on information received in a discovery request and prompts in a prompt task collection 421.

In some embodiments, an NLP ML model may be specified (as indicated at 417). In such cases, the candidate NLP ML model may be the specified one. However, in some embodiments, prompt and NLP ML candidate selection 420 may select one or more NLP ML models from available NLP ML model(s) 423. For example, metadata or other information describing NLP ML models may be maintained that indicates which NLP tasks are supported by that NLP ML model. Such metadata can be evaluated to determine NLP ML models perform the NLP task identified for the discovery request 410. In some embodiments, performance criteria 415 may be used to identify candidate NLP ML models (e.g., based on performance information maintained, in the metadata for instance, for each NLP ML model(s)). In some embodiments, whether or not an NLP ML model 423 is available for tuning or other customization may also be a consideration for selection as a candidate if, for example, performance criteria 415 indicates that tuning may be desirable for the NLP ML model.

Prompt discovery 224 may implement prompt and NLP ML evaluation 430, in various embodiments, in order to evaluate performance of the candidate prompt(s) and candidate NLP ML model(s) for recommendation. For example, one or analysis host(s) 431 may be provisioned and the candidate NLP NL model(s) 433 deployed on the analysis host(s). Test data 435 may be obtained. Test data 435 may be specified or identified as part of discovery request 410 (e.g., by identifying a file, storage location, or other path for accessing test data 435, or test data 435 may be sample input 413). In some embodiments, test data 435 may be maintained by machine learning service 210 for evaluating the identified NLP task. When the test data 435 is obtained, the candidate prompts 432 may be used to generate inferences using the candidate NLP ML model(s) 433 on the test data 435. Results 434 for candidate prompts may be collected. In some embodiments, prompt and NLP ML evaluation 430 may perform an initial analysis by, for example, comparing candidate prompt results 434 sample output 413. Again, a similarity score with sample output 413 may be generated to determine how well candidate prompts and candidate NLP ML models performed, and used to rank or filter out candidate prompt(s) and models, in some embodiments. In some embodiments, a test data sample output may be obtained for inclusion in a prompt recommendation 450 (e.g., as indicated at sample output 453). Other performance metrics may be used for evaluation (e.g., when labeled or ground truth data for test data 435 is used to score the accuracy of the candidate prompt and candidate NLP ML model combination.

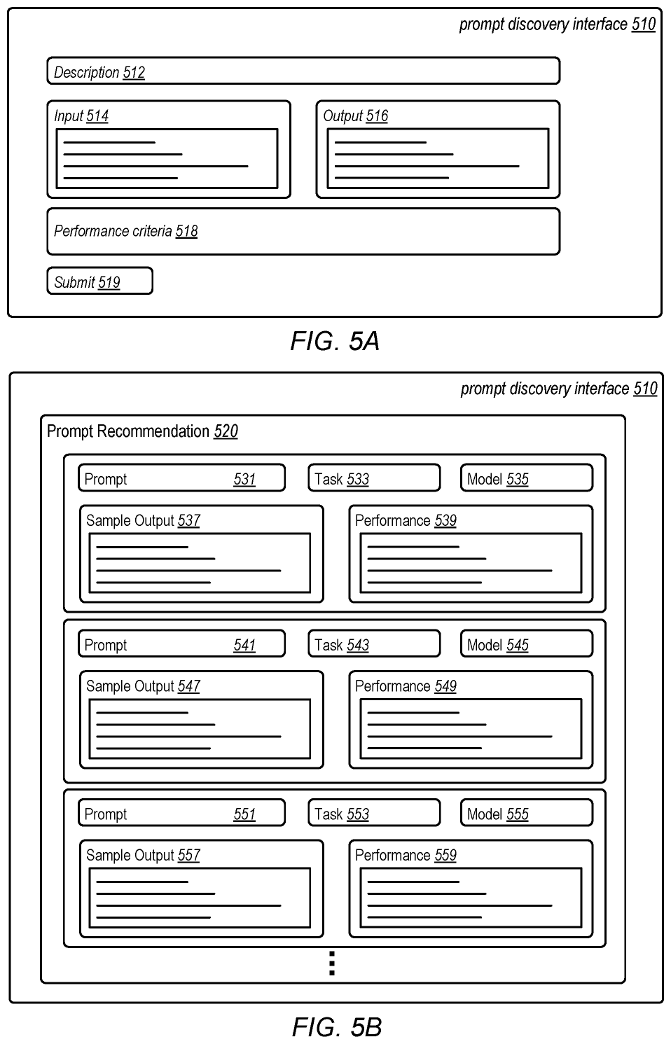

In some embodiments, prompt discovery 224 may implement prompt recommendation generation 440. Prompt recommendation generation 440 may provide a prompt recommendation 450 that includes multiple candidate prompt(s) 451 and NLP ML models 457, or a single recommended prompt (or some combination between, such as one prompt and multiple NLP ML models or multiple prompts and one NLP ML model. In some embodiments, a prompt recommendation may include different combinations of prompt features (e.g., one instruction feature with different possible style features). In some embodiments, prompt recommendations may include in-context learning prompts to consider for evaluation, as discussed in detail below with regard to FIG. 6. In some embodiments, prompt recommendation generation 440 may filter or reduce the number of candidates based on the analys(es) discussed above. Prompt recommendation generation 440 may generate prompt recommendation 450 and include various information, such as prompt(s) 451, sample output 453 for the prompt(s), performance metric(s) 455 for the prompts (e.g., inference time, resources/cost, etc.), the NLP ML model(s) 457 used, and the task identified 459 (e.g., at 410). Prompt recommendations 450 may be presented in various ways, using various visualization techniques, including, but not limited to, ranking, charts, graphs, output displays, etc. FIG. 5B, discussed below, provides an example of a prompt recommendation, in some embodiments.

Although not depicted, in some embodiments various stages of prompt discovery 224 may be interactive such that after a stage, such as NLP task classification 410, prompt and NLP ML candidate selection 420, and prompt and NLP ML evaluation 430, a partial or intermediate result may be provided via the interface. Then, refinement of that intermediate result can be made based on received feedback and prompt discovery processing continue using the refined intermediate result (e.g., to task classification, candidate prompts, or candidate ML models). Similarly, prompt recommendation 450 may be used to select or modify the task 459, NLP ML model 457, or individual prompt(s) 451 for reevaluation with the modifications.

FIG. 5A illustrates an example prompt discovery interface for submitting a discovery request, according to some embodiments. Prompt discovery interface 510 may be implemented as part of prompt-NLP ML model development/management environment 213, in some embodiments. Prompt discovery interface 510 may implement different types of user interface elements for receiving information to include in a prompt discovery request. For example, text input elements may be used to accept a description 512, sample input 514, sample output 516, and performance criteria 518. In some embodiments, various user interface elements used to translate selections into the features of a discovery request, such as drop down menu that is pre-populated with task classifications or a slider/knob that translates between general information (e.g., fast/high cost, slower/low cost). Submit element 519 may submit the discovery request for evaluation.

FIG. 5B illustrates an example prompt discovery interface providing a prompt recommendation, according to some embodiments. Prompt discovery interface 510 may provide a prompt recommendation 520 generated according to the various techniques discussed above. For example, a ranking of recommended prompts may be provided such as prompts 531, 541, and 551, with corresponding output information, such as task classifications 533, 543, and 553, model 535, 545, and 555, sample output 537, 547, and 557, and performance 539, 549, and 559. In some embodiments, prompts could be presented un-ordered. Note that various other arrangements or interactions may be used to submit discovery requests and receive prompt recommendations. Therefore, the examples discussed above with regard to FIGS. 5A and 5B are not intended to be limiting.

FIG. 6 is a logical block diagram illustrating prompt development for NLP tasks, according to some embodiments. Development request(s) 610 may be received at prompt development 226. Development request(s) 610 may be received via graphical interface (e.g., a web console or other user interface implemented as part of prompt-NLP ML model development and management 213). For example, development request(s) 610 may be received as part of an Integrated Development Environment (IDE) for developing prompts for NLP tasks. In some embodiments, a command line or programmatic interface may also be supported for development request(s) 610.

Development request(s) 610 may include various features, such as a prompt 611 (e.g., specified as a text string or identifier of a selected prompt from a task collection) and an NLP ML model 613 (e.g., specified using a name or identifier). In this way, various adaptation jobs can be created to tune prompt 611 and/or the NLP ML model 613. Prompt 611 may be one of the many prompts supported by machine learning service 210 in a task collection selected by browsing or a discovery request that identifies the prompt for an NLP task. In some embodiments, additional information or features may be specified as part of development request(s) 610. For example, tuning configuration 615 may be included, which may specify various adaptation job features, such as hyperparameters for performing tuning, stop criteria or resource utilization limitations, among others. Development request(s) 610 may include identifiers for tuning data set 617 (e.g., an identifier, path, location, or an upload of the adaptation data set) and a test data set 619 (e.g., an identifier, path, location, or an upload of the test data set). Test data set 619 may include ground truth labels, for instance, which may be used to evaluate the performance post tuning.

Prompt development 226 may implement adaptation job generation 620. Adaptation jobs may include different types of tasks. Some types of adaptation jobs may alter the weights or other features of a pre-trained NLP ML model using ML training techniques for tuning model performance. Another type of adaptation job may include techniques that alter performance of the pre-trained NLP ML model without altering the NLP model itself, such as in-context learning. Adaptation job generation 620 may generate configuration files or other artifacts used to execute a development request 610. For example, adaptation job generation 620 may validate various features of development request(s) 610 for correctness and generate a configuration file used to execute an adaption job according to the appropriate machine learning framework by assembling or invoking the adaptation job the various libraries, files, and other information used to adapt pre-trained NLP ML model and/or perform prompt tuning.

In various embodiments, adaptation job management 630 may coordinate the performance of adaptation jobs to implement different types of tuning, including prompt tuning 632, in-context learning 634, and fine tuning 636. Prompt tuning 632 may include various tuning techniques that that freezes core language model parameters of an NLP ML model and instead learns a sequence of soft-tokens for each task/domain. Prompt tuning may allow a machine learning model to learn task-specific prompt tokens (with frozen base model) which can match performance model fine tuning, in some scenarios. Prompt tuning 632 can also be applied at the level of various domains within a given task. For example, learning domain specific prompts can match fine-tuning performance in a low-data setting. By freezing the core language model parameters, prompt tuning 632 seems to be more resilient to domain shifts.

Another type of tuning that adaptation job management 630 may support is fine tuning 636. Fine tuning 636 may be an adaption process to update the parameters (usually all the parameters or a portion of them) of a pre-trained NLP ML model with task-specific and on task-annotated data. In some scenarios, decoding algorithms to input and to take the output representations of the model to carry out the task may be implemented.

Another type of tuning that adaptation job management 630 may support is in-context learning 634. In-context learning 634 may include techniques where text input to a pre-trained language model is used as a form of task specification: the pre-trained NLP ML model is conditioned on a natural language instruction and/or a few demonstrations of the task and is then expected to complete further instances of the task simply by predicting what comes next. During unsupervised pre-training, the pre-trained NLP ML model develops generic pattern recognition abilities (e.g., meta-learning). It then uses these abilities at inference time to rapidly adapt to or recognize the desired task. With no prior information about the task itself, for example if the model is provided the following during inference:
Document: John Doe works for ABC AugmentedDocument: [John Doe| person] works for [ABC| organization]
Document: EU rejects German call to boycott British lamb. AugmentedDocument: [EU| organization] rejects German call to boycott British lamb.
After in-context learning, the NLP ML model can be tuned to handle a further example: Document: the Commission's chief spokesman Nikolaus van der Pas told a news briefing AugmentedDocument: the [Commission| organization]'s chief spokesman [Nikolaus van der Pas| person]

For in-context learning 634, learning about the task occurs within the forward-pass upon each sequence and no parameters updates are performed. This is in contrast with fine-tuning 636 where pairs of source and target sequences are provided and the NLP ML model learns to generate target sequences by parameter updates. Thus for adaptation jobs 631 that perform in-context learning evaluation 660 and analysis host(s) 670 may be the same (as in-context learning may both be performed and tested using the in-context learning prompts prior to the evaluation prompts.

Adaptation job management 630 may support these tuning techniques by managing or coordinating the execution of a generated adaptation job to perform these tuning techniques on adaptation host(s) 660. The pre-trained NLP ML model 661 may be obtained and deployed to adaptation host(s) 660 as well as the tuning data set(s) 662. Adaptation host(s) 660 may execute the adaptation technique(s) identified in adaptation job 631 and then provide the tuned model 633 (or an indication that the tuned model is generated) to adaptation job management.

Prompt and model evaluation 640 may ten execute an evaluation using the tuned NLP ML model 671 and prompt 611 on analysis host(s) 670 using test data 672. When the test data 672 is obtained, the prompt 611 may be used to generate inferences using the tuned NLP ML model(s) 671 on the test data 672. Results 643 for tuned NLP models using prompts may be collected. In some embodiments, prompt and NLP ML evaluation 640 may perform an analysis by, for example, comparing results obtained from multiple different adaptation jobs (e.g., one performing prompt tuning, one performing in-context learning and one performing fine tuning). In some embodiments, a test data sample output may be obtained for inclusion in an adaption job result 650 (e.g., as indicated at sample output 655). Other performance metrics may be used for evaluation (e.g., when labeled or ground truth data for test data 672 is used to score the accuracy of the prompt and tuned NLP ML models.

An adaption job result 650 may be provided, in various embodiments. Adaptation job result 650 may include inference performance information, such as accuracy information. Adaptation job result 650 may also include computational performance 653. For example, adaptation time, adaptation resource utilization, inference performance time, and inference/tuned NLP ML model resource utilization may be included. In some embodiments, adaptation job result 650 may include a sample output 655.

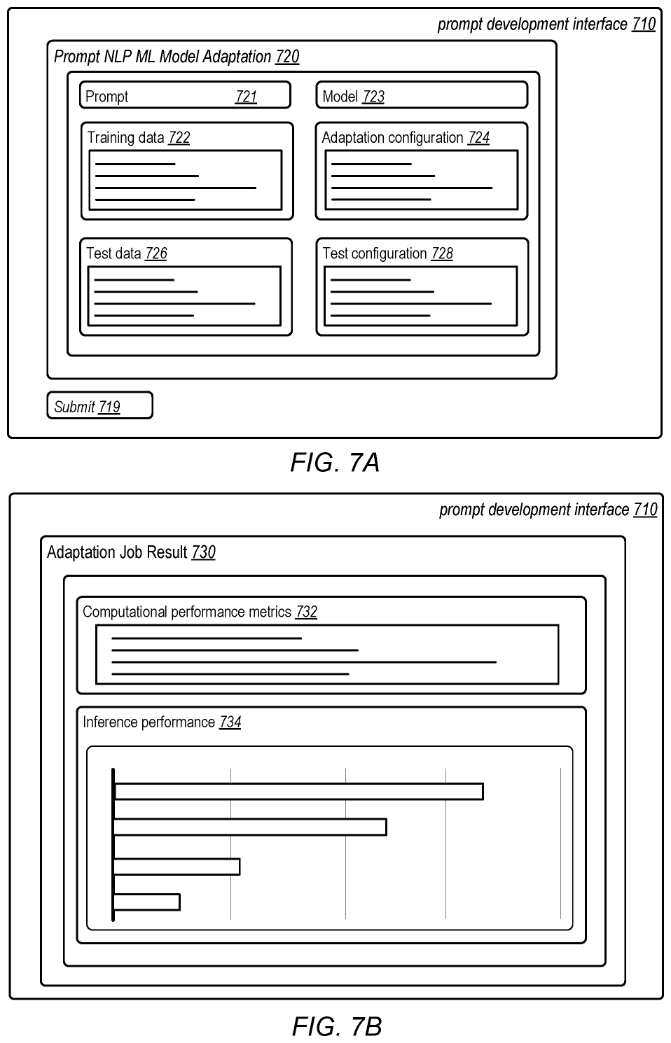

FIG. 7A is an example prompt development interface for performing prompt and NLP ML model tuning, according to some embodiments. Prompt development interface 710 may be implemented as part of prompt-NLP ML model development/management environment 213, in some embodiments. Prompt development interface 710 may implement different types of user interface elements for receiving information to include in a prompt NLP ML model tuning or other development request, as indicated at 720. For example, the prompt 721 (e.g., selected from a prompt task collection) and model 723 (e.g., selected from supported models) may be identified. Adaptation data 722, adaptation configuration 724, test data 726 and test configuration 728 may also be specified in some embodiments, and submitted as indicated at 719.

FIG. 7B is an example prompt development interface for an adaption job result, according to some embodiments. Adaptation job result 730 may be displayed as part of prompt development interface 710. For example, computational performance metrics 732 and inference performance 734 (e.g., accuracy) may be provided. Various different techniques for displaying or visualizing adaptation job result 730 may be implemented. In some embodiments, the performance of different tuning techniques, prompts, and NLP ML models may be compared in a summary or meta-analysis view. Note that various other arrangements or interactions may be used to submit development requests and receive adaptation job results. Therefore, the examples discussed above with regard to FIGS. 7A and 7B are not intended to be limiting.

FIG. 8 is a logical block diagram illustrating model deployment for tune NLP ML models, according to some embodiments. Model deployment 228 may manage and execute requests to deploy NLP ML models discovered and/or tuned using the various techniques discussed above. Model deployment 228 may handle requests, like deployment request 810, which may identify the NLP ML model 812 and a host configuration 814 for the NLP model. For example, the identifier for the NLP ML model 812 may be included so that model deployment 228 can obtain the model artifacts 832 from storage service 230 where tuned NLP ML model 820 is stored (e.g., after tuning). Host configuration 814 may provide resource allocations or other information (e.g., amount of processing capacity, network capacity, memory capacity, etc.) to have on a model host.

Model deployment 228 may provision model host 840 according to the host configuration 814 and configure networking to access model host 840. For example, a model endpoint 852 may be provisioned which is a publicly accessible network endpoint to which an application, such as application 860 can direct requests, such as inference requests with the prompt 861. Model deployment 228 may acknowledge completion of the deployment 850 and include the model endpoint 852. Model host 840 may then return an inference 863 in response to the request to application 860.

Although FIGS. 2-8 have been described and illustrated in the context of a provider network implementing a machine learning service, the various components illustrated and described in FIGS. 2-8 may be easily applied to other machine learning systems that perform NLP tasks. For example, an NLP service may utilize a common NLP ML model, but still offer prompt discovery and prompt development features to further optimize performance. As such, FIGS. 2-8 are not intended to be limiting as to other embodiments of performing prompt discovery and prompt development for NLP processing tasks.

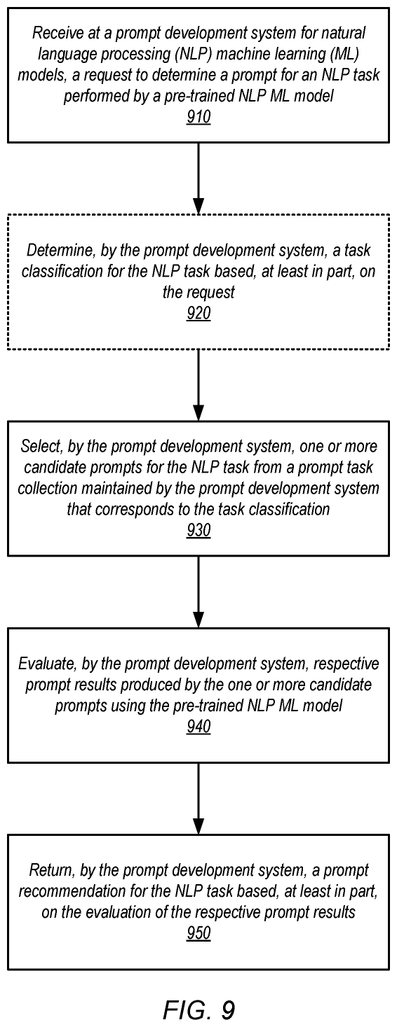

FIG. 9 is a high-level flowchart illustrating various methods and techniques for generating prompt recommendations for NLP processing tasks, according to some embodiments. As indicated at 910, a request to determine a prompt for an NLP task performed by a pre-trained NLP ML model may be received at a prompt development system, according to some embodiments. For example, the request may be received as part of a discovery or search interface for the prompt development system which may offer many different prompts for different NLP tasks. The request may include various information, such as a description (e.g., key words, terms, or other search criteria that can be used to discover prompts), sample input and sample output, performance criteria (e.g., a range or limit on time for returning a response with an inference, a range (or limit) on resources used to host an NLP ML model to generate inferences, or expected size of input), and/or an NLP ML model.

As indicated at 920, a task classification for the NLP task may be determined by the prompt development system based, at least in part, on the request, in some embodiments. For example, a rules-based technique (e.g., using heuristics, rule sets, decision trees, etc.) for task classification may be used to determine an NLP task by parsing the description, sample input/output, and/or performance criteria to determine one (or more) applicable classification rules to apply according to key words found in the parsed information. Key word searches or comparisons may be used to identify a task classification rule set (e.g., action words “list” “summarize” “explain” “identify” etc., entity words, such as “person” “company” “country” “organization”). In some embodiments, an ML technique may be used. For example, an ML model may be trained to generate an encoding of a sample output (or other feature(s) received in the request) and return an inference that identifies an NLP task classification. In some embodiments, the request may explicitly identify the task class (or a task family of related task classes). In some embodiments, task classification techniques may an optimization to a prompt recommendation technique and thus in other embodiments, no task classification determination may be performed (or is optionally performed as request-specified option), as indicated by the dotted line.

As indicated at 930, one or more candidate prompts may be selected for the NLP task from a prompt task collection maintained by the prompt development system, in some embodiments. For example, an index of prompts in task collection may be maintained and searched using the key words. In some embodiments, prompts in task collections may have sample output. A comparison of sample output received in the request with sample outputs of items in the prompts may be used. A similar technique could be performed using sample input (e.g., comparing sample input text with sample input text for prompts). In some embodiments, a combination of various of the comparisons discussed above (or other analyses) may be used. In some embodiments, similarity scores may be generated for prompts in a prompt task collection and used to determine which (if any) prompt candidates to select. In some embodiments, candidate prompts may be selected and then filtered again by other considerations, such as candidate NLP ML model(s) (or a specified one) or performance criteria (e.g., a prompt with slow performance may be discarded if fast prompt performance is desired). In some embodiments, a ML model that generates similarity scores may be used to make comparisons based on information received in a discovery request and prompts in a prompt task collection. In some embodiments, similar techniques may be implemented to select an NLP ML model. In other embodiments, a default NLP ML model (e.g., a base pre-trained NLP ML model offered by the prompt development system) may be used or an NLP ML model specified in the request or corresponding to the task classification may be identified.

As indicated at 940, respective prompt results produced by the one or more candidate prompts produced using the pre-trained NLP model may be evaluated, in some embodiments. For example, test data may be obtained for the identified NLP task. The candidate prompts may be used to generate inferences using the pre-trained NLP ML model on the test data. Inferences with NLP task results for candidate prompts may be collected. In some embodiments, candidate prompt results may be compared with a provided sample output. Again, a similarity score with sample output may be generated to determine how well candidate prompts performed. The similarity scores may be used to rank or filter out candidate prompt(s), in some embodiments.

As indicated at 950, a prompt recommendation may be returned for the NLP task based, at least in part, on the evaluation of the respective prompt results, in some embodiments. For example, a prompt recommendation may be returned that identifies a prompt (or best performing prompt), a sample output for the prompt, an identified NLP task classification, and/or various other information concerning recommended prompt(s). As discussed above, prompt recommendations may include one or multiple prompts, as well as different types or features of prompts, such as instruction features, style features, or in-context learning prompts, in some embodiments.

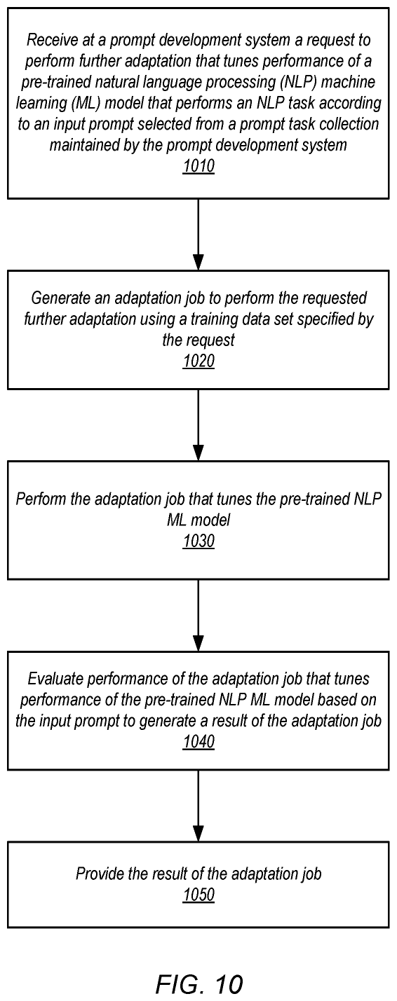

FIG. 10 is a high-level flowchart illustrating various methods and techniques for performing prompt development and tuning using a selected prompt from a task collection, according to some embodiments. As indicated at 1010, a request may be received at a prompt development system to perform further adaptation on a pre-trained NLP ML model that performs an NLP task according to an input prompt selected from a prompt task collection maintained by the prompt development system, in some embodiments. For example, the request may be a prompt selected to provide output to be utilized in a software application (e.g., integrating a text summary feature into a cataloging system or indexing application for documents). The performance of the pre-trained NLP ML model, however, can be tuned to provide greater performance quality with respect to the particular use case that the prompt and model are being used for (e.g., the indexing or cataloging system). Thus, the request may for different prompts to be tried and with an NLP ML model tuned for a specific application, in some embodiments.

As indicated at 1020, an adaption job may be generated to perform the requested further adaptation using an adaption data set specified by the request, in some embodiments. Different types of adaptations such as model changing adaptions, like fine tuning or prompt tuning, or model performance changing without changing the model itself, such as in-context learning may be performed by adaptation jobs. For example, a configuration file, manifest, template, or other executable artifact may be created that identifies the various data and software artifacts used to perform the adaptation job (e.g., ML frameworks, ML model artifacts, adaptation data set (e.g., tuning data set), types of tuning (e.g., in-context, fine-tuning, prompt tuning), hyperparameters, and various other features that control performance of the adaptation job. As indicated at 1030, the adaptation job may be performed that tunes the pre-trained NLP ML model, in some embodiments.

As indicated at 1040, performance of the adaptation job that tunes performance of the pre-trained NLP ML model may be evaluated based on the input prompt to generate a result of the adaptation job, in some embodiments. For example, test data may be obtained and the prompt used to generate inferences using the tuned NLP ML model(s) on the test data. These inferences may then be analyzed by, for example, comparing results obtained from multiple different adaptation jobs (e.g., one performing prompt tuning, one performing in-context learning and one performing fine tuning). In some embodiments, a test data sample output may be obtained for inclusion in an adaption job result. Other performance metrics may be used for evaluation (e.g., when labeled or ground truth data for test data is used to score the accuracy of the prompt and tuned NLP ML models).

As indicated at 1050, the result of the adaptation job may be provided, in some embodiments. For example, various tuned NLP ML model performance information, such as inference performance and computational performance, may be provided, as discussed in detail above

The methods described herein may in various embodiments be implemented by any combination of hardware and software. For example, in one embodiment, the methods may be implemented on or across one or more computer systems (e.g., a computer system as in FIG. 11) that includes one or more processors executing program instructions stored on one or more computer-readable storage media coupled to the processors. The program instructions may implement the functionality described herein (e.g., the functionality of various servers and other components that implement the network-based virtual computing resource provider described herein). The various methods as illustrated in the figures and described herein represent example embodiments of methods. The order of any method may be changed, and various elements may be added, reordered, combined, omitted, modified, etc.

Embodiments of prompt discovery and development techniques as described herein may be executed on one or more computer systems, which may interact with various other devices. One such computer system is illustrated by FIG. 11. In different embodiments, computer system 2000 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing device, computing node, compute node, or electronic device.

In the illustrated embodiment, computer system 2000 includes one or more processors 1010 coupled to a system memory 1020 via an input/output (I/O) interface 1030. Computer system 2000 further includes a network interface 1040 coupled to I/O interface 1030, and one or more input/output devices 1050, such as cursor control device 1060, keyboard 1070, and display(s) 1080. Display(s) 1080 may include standard computer monitor(s) and/or other display systems, technologies or devices. In at least some implementations, the input/output devices 1050 may also include a touch- or multi-touch enabled device such as a pad or tablet via which a user enters input via a stylus-type device and/or one or more digits. In some embodiments, it is contemplated that embodiments may be implemented using a single instance of computer system 2000, while in other embodiments multiple such systems, or multiple nodes making up computer system 2000, may host different portions or instances of embodiments. For example, in one embodiment some elements may be implemented via one or more nodes of computer system 2000 that are distinct from those nodes implementing other elements.

In various embodiments, computer system 2000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, graphics rendering may, at least in part, be implemented by program instructions that execute on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies (AMD), and others.

System memory 1020 may store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above to implement explanation jobs for computer vision tasks, are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 2000. Generally speaking, a non-transitory, computer-readable storage medium may include storage media or memory media such as magnetic or optical media, e.g., disk or CD/DVD-ROM coupled to computer system 2000 via I/O interface 1030. Program instructions and data stored via a computer-readable medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may allow data to be exchanged between computer system 2000 and other devices attached to a network, such as other computer systems, or between nodes of computer system 2000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 2000. Multiple input/output devices 1050 may be present in computer system 2000 or may be distributed on various nodes of computer system 2000. In some embodiments, similar input/output devices may be separate from computer system 2000 and may interact with one or more nodes of computer system 2000 through a wired or wireless connection, such as over network interface 1040.

As shown in FIG. 11, memory 1020 may include program instructions 1025, that implement the various methods and techniques as described herein, and data storage 1035, comprising various data accessible by program instructions 1025. In one embodiment, program instructions 1025 may include software elements of embodiments as described herein and as illustrated in the Figures. Data storage 1035 may include data that may be used in embodiments. In other embodiments, other or different software elements and data may be included.

Those skilled in the art will appreciate that computer system 2000 is merely illustrative and is not intended to limit the scope of the techniques as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 2000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a non-transitory, computer-accessible medium separate from computer system 2000 may be transmitted to computer system 2000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It is noted that any of the distributed system embodiments described herein, or any of their components, may be implemented as one or more web services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the web service in a manner prescribed by the description of the network-based service's interface. For example, the network-based service may describe various operations that other systems may invoke, and may describe a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a web services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP).

In some embodiments, web services may be implemented using Representational State Transfer (“RESTful”) techniques rather than message-based techniques. For example, a web service implemented according to a RESTful technique may be invoked through parameters included within an HTTP method such as PUT, GET, or DELETE, rather than encapsulated within a SOAP message.

The various methods as illustrated in the FIGS. and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A system, comprising:
at least one processor; and
a memory, storing program instructions that when executed by the at least one processor, cause the at least one processor to implement a prompt development system for natural language processing (NLP) machine learning (ML) models, the prompt development system configured to:
receive, via an interface of the prompt development system, a request to determine a prompt for an NLP task performed by a pre-trained NLP ML model;
determine a task classification for the NLP task based, at least in part, on the request;
access a prompt task collection maintained by the prompt development system that corresponds to the task classification and select one or more candidate prompts for the NLP task;
cause the one or more candidate prompts to be provided as input to the pre-trained NLP ML model to generate respective prompt results produced by the pre-trained NLP model;
evaluate the respective prompt results produced by the one or more candidate prompts using the pre-trained NLP ML model to generate a prompt recommendation of the NLP task; and
return, via the interface of the prompt development system, the prompt recommendation for the NLP task.

2. The system of claim 1, wherein to determine the task classification for the NLP task, the prompt development system is configured to evaluate a sample input and sample output specified in the request.

3. The system of claim 1, wherein the prompt development system is further configured to:
receive the one or more candidate prompts as prompt submissions to be maintained by the prompt development system; and
add the one or more candidate prompts to the prompt task collection.

4. The system of claim 1, wherein the prompt development system is implemented as part of a machine learning service offered by a provider network, wherein the prompt task collection is one of a plurality of different prompt task collections maintained by the machine learning service that are collections of prompts submitted to the machine learning service via an interface of the machine learning service.

5. A method, comprising:
receiving, at a prompt development system for natural language processing (NLP) machine learning (ML) models, a request to determine a prompt for an NLP task performed by a pre-trained NLP ML model;
selecting, by the prompt development system, one or more candidate prompts for the NLP task from a prompt task collection maintained by the prompt development system;
evaluating, by the prompt development system, respective prompt results produced by the one or more candidate prompts using the pre-trained NLP ML model; and
returning, by the prompt development system, a prompt recommendation for the NLP task based, at least in part, on the evaluating of the respective prompt results.

6. The method of claim 5, further comprising determining, by the prompt development system, a task classification for the NLP task based, at least in part, on the request, wherein the prompt task classification corresponds to the task classification.

7. The method of claim 6, wherein determining the task classification for the NLP task comprises identifying the task classification as specified in the request.

8. The method of claim 6, wherein determining the task classification for the NLP task comprises evaluating a sample input and sample output specified in the request.

9. The method of claim 5, wherein the prompt recommendation comprises two or more of the candidate prompts with respective samples outputs for comparison.

10. The method of claim 5, further comprising selecting, by the prompt development system, one or more candidate pre-trained NLP ML models that corresponds to the task classification.

11. The method of claim 5, wherein the prompt recommendation comprises an instruction and a stylistic feature.

12. The method of claim 5, wherein the prompt recommendation comprises computational performance for one of the candidate prompts included in the prompt recommendation.

13. The method of claim 5, wherein the prompt recommendation is further generated based on an evaluation of the one or more candidate prompts with respect to performance criteria specified in the request.

14. The method of claim 5, further comprising:
receiving, by the prompt development system, the one or more candidate prompts as prompt submissions to be maintained by the prompt development system; and
adding, by the prompt development system, the one or more candidate prompts to the prompt task collection.

15. One or more non-transitory, computer-readable storage media, storing program instructions that when executed on or across one or more computing devices cause the one or more computing devices to implement:
receiving, at a prompt development system for natural language processing (NLP) machine learning (ML) models, a request to determine a prompt for an NLP task performed by a pre-trained NLP ML model;
selecting, by the prompt development system, one or more candidate prompts for the NLP task from a prompt task collection maintained by the prompt development system that corresponds to the task classification;
causing, by the prompt development system, an evaluation of respective prompt results produced by the one or more candidate prompts using the pre-trained NLP ML model; and
returning, by the prompt development system, a prompt recommendation for the NLP task based, at least in part, on the evaluating of the respective prompt results.

16. The one or more non-transitory, computer-readable storage media of claim 15, wherein a task classification is specified in the request, wherein the prompt task collection corresponds to the task classification.

17. The one or more non-transitory, computer-readable storage media of claim 15, storing further program instructions that when executed on or across the one or more computing devices to further implement evaluating a sample input and sample output specified in the request to determine a task classification, wherein the prompt task collection corresponds to the task classification.

18. The one or more non-transitory, computer-readable storage media of claim 14, wherein the request does not specify the pre-trained NLP ML model, and wherein the prompt recommendation comprises an identification of the pre-trained NLP ML model.

19. The one or more non-transitory, computer-readable storage media of claim 14, storing further program instructions that when executed on or across the one or more computing devices cause the one or more computing devices to further implement:
receiving, by the prompt development system, the one or more candidate prompts as prompt submissions to be maintained by the prompt development system; and
adding, by the prompt development system, the one or more candidate prompts to the prompt task collection.

20. The one or more non-transitory, computer-readable storage media of claim 14, wherein the prompt development system is implemented as part of a machine learning service offered by a provider network, wherein the prompt task collection is one of a plurality of different prompt task collections maintained by the machine learning service that are collections of prompts submitted to the machine learning service via an interface of the machine learning service.
